(19) United States
(12) Patent Application Publication
(10) Pub. No.: US 2020/0200344 A1
(43) Pub. Date: Jun. 25, 2020

(54) DAYLIGHTING MEMBER AND DAYLIGHTING DEVICE

(71) Applicant: SHARP KABUSHIKI KAISHA, Sakai City, Osaka (JP)

(72) Inventors: YASUSHI ASAOKA, Sakai City, Osaka (JP); SHUN UEKI, Sakai City, Osaka (JP); TSUYOSHI KAMADA, Sakai City, Osaka (JP)

(21) Appl. No.: 16/623,637

(22) PCT Filed: Jun. 19, 2018
(86) PCT No.: PCT/JP2018/023239

§ 371 Date: Dec. 17, 2019

(30) Foreign Application Priority Data
Jun. 19, 2017 (JP) 2017-119661

(51) Int. Cl. F21S 11/00; E06B 9/42; G02B 5/02

(52) U.S. Cl. CPC F21S 11/007; G02B 5/0205; E06B 9/42

(57) ABSTRACT

A daylighting member includes a flat plate structure body including a plurality of prism structure elements, in which the plurality of prism structure elements are provided in parallel on a first surface side of the flat plate structure body, the flat plate structure body has an incident surface, a reflecting surface, and an emitting surface, the incident surface, the reflecting surface, and the emitting surface are not parallel to each other, and each of the prism structure elements has a function of suppressing wavelength dispersion of light transmitted through the prism structure element.

### TECHNICAL FIELD

Some aspects of the present invention relate to a daylighting member and a daylighting device.

This application claims priority based on Japanese Patent Application No. 2017-119661 filed in Japan on June 19, 2017, the content of which is incorporated herein.

### BACKGROUND ART

PTL 1 discloses a daylighting device that takes sunlight into a room through a window or the like of a building. PTL 1 described below discloses a daylighting tool including a light control member that deflects light, which is incident from a first main surface, toward a second main surface, and a dispersion suppressing member one main surface of which is a flat surface and the other main surface of which has an irregularity structure. PTL 1 describes that the daylighting tool of the invention includes the dispersion suppressing member having the irregularity structure and thus iridescent unevenness in a radiation region is able to be suppressed and a person in the room does not feel uncomfortable.

### CITATION LIST

### Patent Literature

PTL 1: Japanese Unexamined Patent Application Publication No. 2016-70941

### SUMMARY OF INVENTION

### Technical Problem

In the daylighting tool of PTL 1, light perpendicularly incident on the dispersion suppressing member is equally dispersed into up and down directions by the irregularity structure. Meanwhile, in light obliquely incident on the dispersion suppressing member, a quantity of light incident on an upper surface of the irregularity structure and a quantity of light incident on a lower surface thereof are different, thus posing a problem that an effect of suppressing iridescent unevenness in the radiation region is not sufficiently obtained. Note that, in the present specification, iridescent unevenness refers to that wavelength dispersion is caused in light emitted from a daylighting member and a color of the light appears to be separated like a rainbow for eyes of a user.

An aspect of the invention is made to solve the aforementioned problem and an object thereof is to provide a daylighting member capable of suppressing iridescent unevenness by emitted light. Further, an object thereof is to provide a daylighting device including the daylighting member.

### Solution to Problem

In order to achieve the aforementioned objects, a daylighting member of an aspect of the invention includes a flat plate structure body including a plurality of prism structure elements, in which the plurality of prism structure elements are provided in parallel on a first surface side of the flat plate structure body, the flat plate structure body has an incident surface, a reflecting surface, and an emitting surface, the incident surface, the reflecting surface, and the emitting surface are not parallel to each other, and each of the prism structure elements has a function of suppressing wavelength dispersion of light transmitted through the prism structure element.

In the daylighting member of an aspect of the invention, the prism structure element may be formed of a material that contains a base material and a plurality of particles having a refractive index different from a refractive index of the base material and dispersed into the base material.

In the daylighting member of an aspect of the invention, a half or more of a region of a surface area of each of the plurality of particles may be covered with the base material.

In the daylighting member of an aspect of the invention, the base material may be formed of a material that has an Abbe number of 50 or more, the refractive index of 1.45 or more and 1.58 or less, and visible light transmissivity.

In the daylighting member of an aspect of the invention, the prism structure element may be formed of a material that has an Abbe number of 50 or more, a refractive index of 1.45 or more and 1.58 or less, and visible light transmissivity.

In the daylighting member of an aspect of the invention, the flat plate structure body may further include a light transmitting portion provided in a region between two of the prism structure elements adjacent to each other, and the light transmitting portion may have a function of suppressing wavelength dispersion of light transmitted through the light transmitting portion.

In the daylighting member of an aspect of the invention, the light transmitting portion may contain a light scattering particle.

A daylighting device of an aspect of the invention includes: the daylighting member of the aspect of the invention; and a support member that supports the daylighting member.

The daylighting device of an aspect of the invention may further include a light diffusing member provided on a light emitting side of the daylighting member.

### Advantageous Effects of Invention

According to an aspect of the invention, a daylighting member capable of suppressing iridescent unevenness by emitted light is able to be achieved. Further, according to an aspect of the invention, a daylighting device including the daylighting member is able to be achieved.

### BRIEF DESCRIPTION OF DRAWINGS

FIG. 1 is a sectional view of a daylighting member of a first embodiment.

FIG. 2A illustrates angle distribution of incident light intensity of light on the daylighting member.

FIG. 2B is a view for explaining a problem of a conventional daylighting member.

FIG. 2C is a view for explaining an action of the daylighting member of the present embodiment.

FIG. 3 is a sectional view illustrating a first modified example of a daylighting member.

FIG. 4 is a sectional view illustrating a second modified example of a daylighting member.

FIG. 5 is a sectional view of a daylighting member of a second embodiment.

FIG. 6 is a sectional view of a daylighting member of a third embodiment.

FIG. 7 illustrates an example of wavelength dispersion of refractive indexes of a plurality of kinds of resin materials.

FIG. 8 is a graph illustrating a relationship between an incident angle and a transmittance of light.

FIG. 9 is a graph illustrating a relationship between a refractive index and a total reflection angle.

FIG. 10 is a schematic view for explaining a method of evaluating a trial of a daylighting member manufactured by inventors.

FIG. 11 is a graph illustrating an evaluation result of wavelength dispersion of a daylighting member when a material A is used.

FIG. 12 is a graph illustrating an evaluation result of wavelength dispersion of a daylighting member when a material B is used.

FIG. 13 is a view for explaining an action of the daylighting member of the present embodiment.

FIG. 14 is a sectional view of a daylighting member of a fourth embodiment.

FIG. 15 is a sectional view of a daylighting device of a fifth embodiment.

FIG. 16 is a sectional view of a daylighting device of a first modified example.

FIG. 17 is a sectional view of a daylighting device of a second modified example.

FIG. 18 is a sectional view of a daylighting device of a third modified example.

FIG. 19 is a perspective view of a daylighting device of a sixth embodiment.

FIG. 20 is a sectional view of the daylighting device.

FIG. 21 is a perspective view of a daylighting device of a seventh embodiment.

FIG. 22 is a sectional view of the daylighting device.

FIG. 23 is a sectional view of a room where the daylighting device is installed.

FIG. 24 is a plan view illustrating a ceiling of the room.

FIG. 25 is a graph illustrating a relationship between illuminance of light (natural light) taken into the room by the daylighting device and illuminance by indoor illumination devices.

### DESCRIPTION OF EMBODIMENTS

### First Embodiment: Daylighting Member

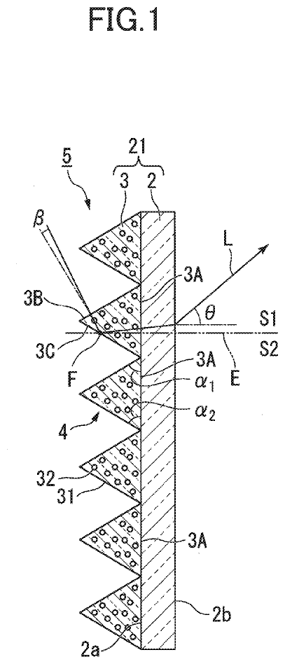

A first embodiment of the invention will be described below with reference to FIGS. 1 to 4.

In the first embodiment, an example of a daylighting film is cited as an example of a daylighting member of the invention. The daylighting film of the present embodiment is installed, for example, near window glass and used to take sunlight in a ceiling direction into a room.

FIG. 1 is a sectional view of the daylighting member of the first embodiment.

In the following description, a positional relationship (up and down, right and left, front and back) of portions of a daylighting device is based on a positional relationship (up and down, right and left, front and back) as viewed from a user in the room, and unless otherwise described, the positional relationship of the portions of the daylighting device also coincides with a positional relationship in a sheet of the figure.

Moreover, in the figures below, a scale may be varied among components for clarity of the components.

As illustrated in FIG. 1, a daylighting member 5 is provided with a flat plate structure body 21 that includes a base 2 having light transmissivity and a plurality of prism structure elements 3 provided on a first surface 2a of the base 2 and having light transmissivity. Further, a gap 4 is provided between adjacent prism structure elements 3. In the present embodiment, the daylighting member 5 is installed so that the first surface 2a of the base 2, on which the plurality of prism structure elements 3 are provided, faces an outdoor side.

As the base 2, for example, a light transmissive base formed of resins such as thermoplastic polymer, thermosetting resin, or photopolymerizable resin is used. A light transmissive base having acrylic polymer, olefin polymer, vinyl polymer, cellulose polymer, amide polymer, fluorine polymer, urethane polymer, silicone polymer, imide polymer, or the like is used. Specifically, for example, a light transmissive base such as a triacetylcellulose (TAC) film, a polyethylene terephthalate (PET) film, a cycloolefin polymer (COP) film, a polycarbonate (PC) film, a polyethylene naphthalate (PEN) film, a polyether sulfone (PES) film, or a polyimide (PI) film is preferably used. In the present embodiment, a PET film having a thickness of 100 μm is used as an example. A total light transmittance of the base 2 is preferably equal to or more than 90%, for example. Thereby, it is possible to obtain sufficient transparency.

Each of the prism structure elements 3 is formed of a material that contains a base material 31 and a plurality of light scattering particles 32 dispersed into the base material 31. Each of the light scattering particles 32 has a refractive index different from a refractive index of the base material 31. Thereby, the prism structure element 3 has a function of suppressing wavelength dispersion of light transmitted through the prism structure element 3 as described below.

The base material 31 is formed of an organic material, for example, such as acryl resin, epoxy resin, or silicone resin, which has light transmissivity and photosensitivity. A mixture made of transparent resin obtained by mixing, into such resin, a polymerization initiator, a coupling agent, a monomer, an organic solvent, or the like is also able to be used.

Further, the polymerization initiator may contain various additional components, such as a stabilizer, an inhibitor, a plasticizer, a fluorescent brightener, a release agent, a chain transfer agent, and other photopolymerizable monomers. A total light transmittance of the base material 31 is preferably equal to or more than 90%. Thereby, it is possible to obtain sufficient transparency.

The light scattering particles 32 have a function of scattering light incident on the prism structure element 3. The light scattering particles 32 are particles (small pieces) that have the refractive index different from that of the base material 31. It is desirable that the light scattering particles 32 are mixed into the base material 31 and dispersed without aggregation. It is desirable that a half or more region of a surface area of each of the plurality of light scattering particles 32 is covered with the base material 31.

As the light scattering particles 32, for example, a light transmissive material that is composed of glasses, resins such as acrylic polymer, olefin polymer, vinyl polymer, cellulose polymer, amide polymer, fluorine polymer, urethane polymer, silicone polymer, imide polymer, or the like is used. Alternatively, the light scattering particles 32 may be air bubbles dispersed in the base material 31. A shape of each of the light scattering particles 32 may be a globular shape, an ellipse globular shape, a flat plate shape, a polyhedron, or the like, for example. Sizes of the light scattering particles 32 only need to be, for example, about 0.5 to 20 μm, and may be uniform or different.

The prism structure element 3 is a member that linearly extends in one direction (direction perpendicular to a sheet of FIG. 1) so as to be thin and long, and is a member whose sectional shape in a direction orthogonal to a longitudinal direction is a triangle. The prism structure element 3 is parallel to one side of the base 2 in the longitudinal direction. The plurality of prism structure elements 3 are arranged side by side in a vertical direction so as to be parallel to each other.

In this example, the sectional shape of the prism structure element 3 is an isosceles triangle. In the sectional shape of the prism structure element 3, an angle al formed by a surface 3A and a surface 3B and an angle α₂ formed by the surface 3A and a surface 3C are each 65°, for example. Moreover, the prism structure element 3 has a function of reflecting light, which is incident from the surface 3B that is one of the surface 3B and the surface 3C, by the other surface 3C and thereby taking sunlight into the room. In this case, the surface 3C is referred to as a reflecting surface 3C in the following description.

Though sunlight L passing through window glass may take various paths when being incident on the prism structure element 3 and emitted from the base 2, a typical one is illustrated in FIG. 1.

In the prism structure element 3, any one light ray of light incident into an inside is emitted from a bottom surface 3A side through a point F at which the light ray is incident on the reflecting surface 3C. Here, among two spaces S1 and S2 bordering with a virtual plane E vertical to the first surface 2a of the base 2 and parallel to a direction (X direction) in which the prism structure element 3 extends, a space that contains a light ray incident on the point F is defined as a first space S1 and a space that contains no light ray incident on the point F is defined as a second space S2. In this case, the prism structure element 3 has a characteristic of causing the light reflected by the reflecting surface 3C to be emitted from a second surface 2b side of the base 2 and travel toward the first space S1. By such an action of the prism structure element 3, the daylighting member 5 takes the sunlight L into the room and guides the sunlight L in the ceiling direction.

Accordingly, in the flat plate structure body 21, the surface 3B of the prism structure element 3 is an incident surface of the sunlight L, the surface 3C is a reflecting surface of the sunlight L, and the second surface 2b of the base 2 is an emitting surface of the sunlight L. In this manner, the flat plate structure body 21 has the incident surface, the reflecting surface, and the emitting surface, and the incident surface, the reflecting surface, and the emitting surface are not parallel to one another.

There is air in the gap 4. Thus, a refractive index of the gap 4 is almost 1.0. When the refractive index of the gap 4 is 1.0, a critical angle in an interface between the gap 4 and the prism structure element 3 is minimum. In a case of the present embodiment, the gap 4 is an air layer composed of air, but the gap 4 may be set as, for example, a closed space covered by another member to serve as an inert gas layer composed of inert gas such as nitrogen or a reduced pressure layer brought into a state where pressure is reduced.

Instead of such a configuration, another material with a low refractive index may be filled in a space between prism structure elements 3 adjacent to each other. However, a difference in refractive index in the interface between the prism structure element 3 and the gap 4 is maximum in a case where there is air in the gap 26 than a case where there is any other material with a low refractive index in the gap 26. Thus, in the case where there is air in the gap 4 between the adjacent prism structure elements 3, according to Snell's law, the critical angle of light that is totally reflected by the reflecting surface 3c in the sunlight L incident on the prism structure element 3 is minimum.

The daylighting member 5 having the aforementioned configuration is created, for example, by an ultraviolet (UV) transfer method using UV curing resin. Alternatively, the daylighting member 5 is created by an extrusion molding method with use of a thermoplastic wavelength dispersion control member.

A problem of a conventional daylighting member and an action and an effect of the daylighting member of the present embodiment will be described below.

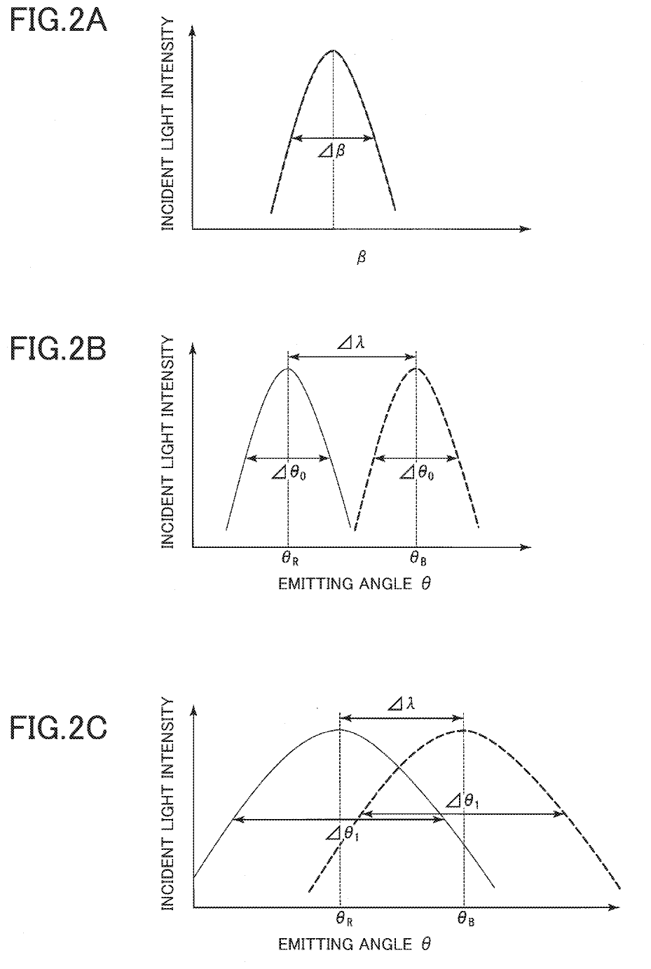

FIG. 2A illustrates angle distribution of incident light intensity of sunlight on the daylighting member.

As illustrated in FIG. 2A, the sunlight incident on the daylighting member does not have wavelength dependency of an incident angle β and angle distribution of the incident angle β has a limited half-value width Δβ.

In a case of the conventional daylighting member that does not have a wavelength dispersion suppressing function, when the sunlight is incident on the daylighting member at the predetermined incident angle p, wavelength dispersion of light is caused, resulting that an emitting angle θ of light varies depending on a wavelength.

For example, as illustrated in FIG. 2B, an angle difference AX, is generated between a median OR of emitting angle distribution of red light (for example, with the wavelength of 650 nm) and a median OB of emitting angle distribution of blue light (for example, with the wavelength of 450 nm). Moreover, the emitting angle distribution of the red light and the emitting angle distribution of the blue light each have a certain limited half-value width Δθ0.

At this time, in a situation where Δθ0<Δλ is satisfied, the emitting angle distribution of the red light and the emitting angle distribution of the blue light do not overlap and the red light and the blue light appear to be separated. As a result, iridescent unevenness in which a color changes from blue to red is visually recognized in a radiation region of the ceiling or the like in the room and a person in the room feels uncomfortable.

On the other hand, in a case of the daylighting member 5 of the present embodiment including the prism structure element 3 containing the light scattering particles 32, for example, as illustrated in FIG. 2C, light is scattered by the light scattering particles 32 when traveling in the prism structure element 3, so that a half-value width Δθ1 of the emitting angle distribution of each of the red light and the blue light is greater than the half-value width Δθ0 indicated in FIG. 2B. Thereby, the red light and the blue light are mixed and dispersion of emitted light is suppressed. Note that, in a case of the present embodiment, the emitting angle difference Δλ between the red light and the blue light does not change as compared with a conventional one.

At this time, in a situation where Δθ0<Δθ1 and Δθ1≥Δλ are satisfied, a comfortable space where the red light and the blue light are not visually recognized as being separated by eyes of the user, coloring of light in the radiation region of the ceiling or the like in the room is suppressed, and the person in the room does not feel uncomfortable is able to be provided. In a case where Δθ1 is too great, however, unintended light more downward than a horizontal plane increases and an unpleasant environment may be provided in some cases due to reduction in illuminance of the ceiling, an increase of glare, or the like. Thus, it is desirable that a type, a size, a content or the like of the light scattering particles 32 in the prism structure element 3 is appropriately adjusted to adjust a degree of scattering so as not to be too great.

As described above, according to the daylighting member 5 of the present embodiment, light of different colors is scattered by the light scattering particles 32 in the prism structure element 3 and mixed, so that dispersion of emitted light is suppressed. As a result, the daylighting member 5 capable of suppressing iridescent unevenness by emitted light is able to be achieved. Though the daylighting member of PTL 1 described above has a problem that an effect of suppressing iridescent unevenness is not sufficiently obtained because of an incident angle of light, the daylighting member 5 of the present embodiment achieves a light scattering effect by causing light to pass through the prism structure element 3 regardless of an incident angle of light and is able to exert an effect of suppressing iridescent unevenness.

Note that, when many light scattering particles 32 protrude to a surface of the prism structure element 3 and flatness of the surface is reduced, reflectivity as the reflecting surface is reduced and deterioration of a daylighting property is caused. Meanwhile, in the daylighting member 5 of the present embodiment, since a half or more region of a surface area of each of the plurality of light scattering particles 32 is covered with the base material 31, a surface area of a part exposed from the incident surface or the reflecting surface of the prism structure element 3 in all the surface area of the light scattering particle 32 is relatively small so that a desired daylighting property is able to be kept.

Moreover, according to the aforementioned configuration, since a half or more of the light scattering particle 32 is buried in the base material 31, missing of the light scattering particle 32 from the prism structure element 3 is able to be suppressed.

Note that, though the daylighting member 5 of the present embodiment includes the prism structure element 3 having the triangular sectional shape, the sectional shape of the prism structure element is not limited to the triangular shape and a configuration of a modified example below is able to be adopted. Further, without limitation to the modified example below, a prism structure element having still another sectional shape is able to be adopted.

### First Modified Example

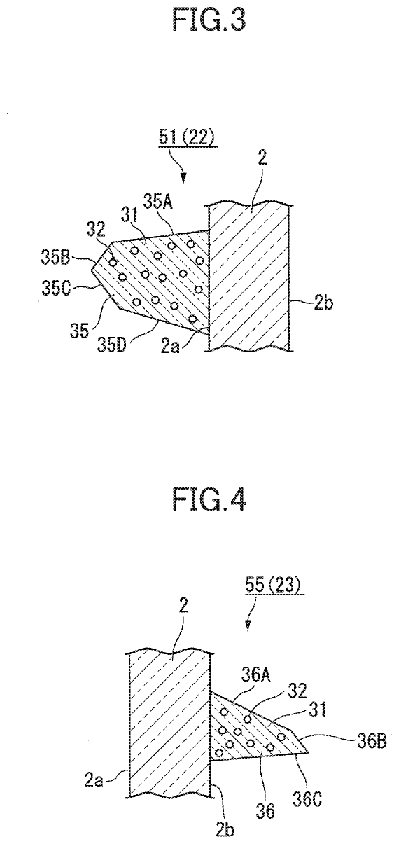

FIG. 3 is a sectional view illustrating a first modified example of a daylighting member.

As illustrated in FIG. 3, a daylighting member 51 of the first modified example is provided with a flat plate structure body 22 that includes the base 2 and a plurality of prism structure elements 35 provided on the first surface 2a of the base 2 and having light transmissivity. In the present embodiment, the daylighting member 51 is installed so that the first surface 2a of the base 2, in which the plurality of prism structure elements 35 are provided, faces the outdoor side.

A sectional shape taken perpendicularly to a longitudinal direction of a prism structure element 35 is a pentagon. In the prism structure element 35, a surface 35A and a surface 35B each mainly function as an incident surface and a surface 35C and a surface 35D each mainly function as a reflecting surface. The second surface 2b of the base 2 functions as an emitting surface. The incident surface, the reflecting surface, and the emitting surface are not parallel to one another. Moreover, the prism structure element 35 contains the base material 31 and the plurality of light scattering particles 32 and has a function of suppressing wavelength dispersion of light transmitted through the prism structure element 35.

### Second Modified Example

FIG. 4 is a sectional view illustrating a second modified example of a daylighting member.

As illustrated in FIG. 4, a daylighting member 55 of the second modified example is provided with a flat plate structure body 23 that includes the base 2 and a plurality of prism structure elements 36 provided on the second surface 2b of the base 2 and having light transmissivity. In the present embodiment, the daylighting member 55 is installed so that the second surface 2b of the base 2, in which the plurality of prism structure elements 3 are provided, faces an indoor side.

A sectional shape taken perpendicularly to a longitudinal direction of a prism structure element 36 is a quadrangle. In the prism structure element 36, a surface 36C functions as a reflecting surface and a surface 36A and a surface 36B each function as an emitting surface. The first surface 2a of the base 2 functions as an incident surface. The incident surface, the reflecting surface, and the emitting surface are not parallel to one another. Moreover, the prism structure element 36 contains the base material 31 and the plurality of light scattering particles 32 and has a function of suppressing wavelength dispersion of light transmitted through the prism structure element 36.

### Second Embodiment: Daylighting Member

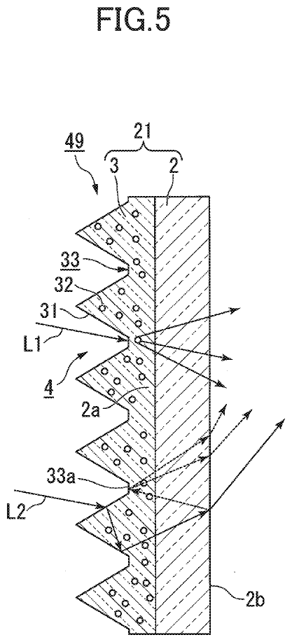

A daylighting member of a second embodiment will be described below with reference to FIG. 5.

A basic configuration of the daylighting member of the second embodiment is the same as that of the first embodiment and a configuration of the first surface side of the base is different from that of the first embodiment.

FIG. 5 is a sectional view of the daylighting member of the second embodiment.

In FIG. 5, a component common to that in the figure used in the first embodiment will be given the same reference sign and description thereof will be omitted.

As illustrated in FIG. 5, a daylighting member 49 is provided with a flat plate structure body 24 that includes the base 2, the plurality of prism structure elements 3, and a plurality of light transmitting portions 33. In the present embodiment, the daylighting member 57 is installed so that the first surface 2a of the base 2, in which the plurality of prism structure elements 37 are provided, faces the outdoor side.

Each of the light transmitting portions 33 is provided in a region between two adjacent prism structure elements 3 on the first surface 2a of the base 2. That is, the light transmitting portion 33 is provided so as to have a thickness from the first surface 2a of the base 2 sufficiently thinner than a height of a prism structure element 3 and fill a part of a valley portion between two adjacent prism structure elements 3.

The light transmitting portion 33 includes the base material 31 integrated with the base material that forms the prism structure element 3 and the plurality of light scattering particles 32 contained in the base material 31. Similarly to the prism structure element 3, also in the light transmitting portion 33, each of the light scattering particles 32 has a refractive index different from that of the base material 31. Thereby, the light transmitting portion 33 has a function of suppressing wavelength dispersion of light transmitted through the light transmitting portion 33.

The other configuration is similar to that of the first embodiment.

The present embodiment also exerts an effect similar to that of the first embodiment that the daylighting member 49 capable of suppressing iridescent unevenness by emitted light is able to be achieved.

Further, in a case of the present embodiment, since the light transmitting portion 33 containing the light scattering particles 32 is provided between two adjacent prism structure elements 3, light incident on a part between the adjacent prism structure elements 3 like light indicated by a reference sign L1 in FIG. 5 hits a light scattering particle 32 and is scattered. Thereby, light that travels straight between the adjacent prism structure elements 3 and leaks is able to be reduced and unpleasant direct sunlight on a window side is able to be suppressed.

Moreover, light reflected by the second surface 2b (emitting surface) of the base 2 like light indicated by a reference sign L2 in FIG. 5 is reflected again by a surface 33a of the light transmitting portion 33 and is scattered by the light scattering particle 32 when traveling toward the second surface 2b of the base 2. Thereby, iridescent unevenness is able to be further improved. Note that, the surface 33a of the light transmitting portion 33 is parallel to the first surface a of the base 2 in this example, but may not be necessarily parallel to the first surface a of the base 2, may be inclined relative to the first surface a of the base 2, or may be provided with irregularity.

### Third Embodiment: Daylighting Member

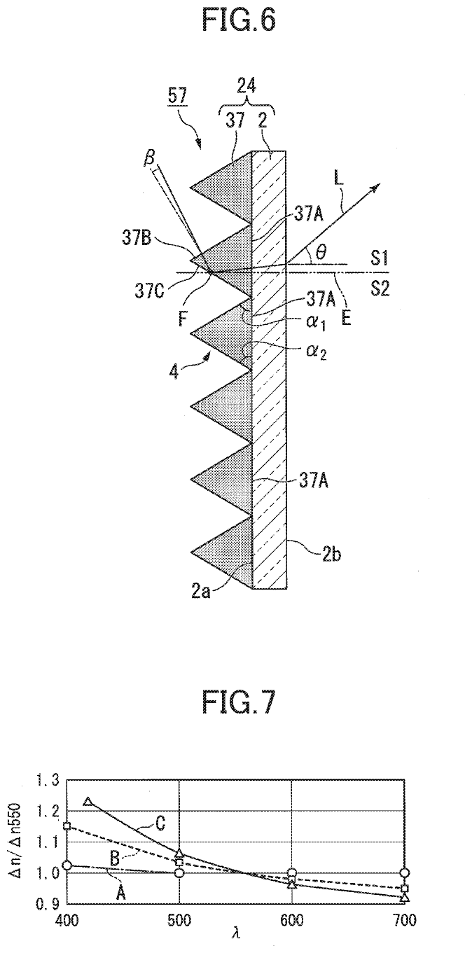

A daylighting member of a third embodiment will be described below with reference to FIGS. 6 to 13.

A basic configuration of the daylighting member of the third embodiment is the same as that of the first embodiment and a configuration of a prism structure element is different from that of the first embodiment.

FIG. 6 is a sectional view of the daylighting member of the third embodiment.

In FIGS. 6 to 13, a component common to that in the figure used in the first embodiment will be given the same reference sign and description thereof will be omitted.

As illustrated in FIG. 6, a daylighting member 57 is provided with the flat plate structure body 24 that includes the base 2 having light transmissivity and a plurality of prism structure elements 37 provided on the first surface 2a of the base 2 and having light transmissivity. In the present embodiment, the daylighting member 57 is installed so that the first surface 2a of the base 2, in which the plurality of prism structure elements 37 are provided, faces the outdoor side.

Each of the prism structure elements 37 is formed of a material that has an Abbe number of 50 or more, a refractive index of 1.45 or more and 1.58 or less, and visible light transmissivity. When such a kind of material is used, the prism structure element 37 has a function of suppressing wavelength dispersion of light transmitted through the prism structure element 37.

FIG. 7 illustrates an example of wavelength dispersion of refractive indexes of a plurality of kinds of resin materials.

In FIG. 7, a horizontal axis indicates a wavelength λ [nm] and a vertical axis indicates a ratio (Δn/Δn₅₅₀) of a refractive index in each wavelength (Δn) relative to a refractive index (Δn₅₅₀) at a wavelength of 550 nm. A curved line by a reference sign A indicates cycloolefin polymer (COP), a curved line by a reference sign B indicates polycarbonate (PC), and a curved line by a reference sign C indicates polyether sulfone (PES).

As illustrated in FIG. 7, the refractive index of a general material monotonously decreases as a wavelength is lengthened. However, wavelength dispersion (inclination of a curved line) of the refractive index varies depending on a material. In the example of FIG. 7, the wavelength dispersion of the COP is relatively low and the wavelength dispersion of the PES is relatively high.

Thus, as an index quantitatively indicating a degree of wavelength distribution of each material, there is an Abbe number. When refractive indexes to C line (wavelength of 656 nm), D line (589 nm), and F line (486 nm) of Fraunhofer lines are respectively defined as nC, nD, and nF, an Abbe number vd is defined by the following equation (1).

vd=(nD−1)/(nF−nC) . . . (1)

When the wavelength dispersion of the refractive index is low, the Abbe number vd increases, and when the wavelength dispersion of the refractive index is high, the Abbe number vd decreases. Generally, the Abbe number vd of resin with a low refractive index tends to be large and the Abbe number vd of resin with a high refractive index tends to be small.

The following table 1 indicates an example of refractive indexes and Abbe numbers in a plurality of kinds of resin materials.

TABLE 1

| Name of resin material | Refractive index | Abbe number |
|---|---|---|
| Cycloolefin polymer | 1.53 | 56 |
| Cycloolefin copolymer | 1.54 | 56 |
| PMMA | 1.49 | 58 |
| Methacrylate (K-55) | 1.51 | 58 |
| Polystyrene | 1.59 | 31 |
| PET | 1.58 | 39 |

In the present embodiment, since a constituent material of the prism structure element 37 has the Abbe number of 50 or more and the refractive index of 1.45 or more and 1.58 or less, cycloolefin polymer (COP), cycloolefin copolymer, polymethyl methacrylate (PMMA), methacrylate (K-55) are able to be used among the resin materials indicated in the table 1. Additionally, as the constituent material of the prism structure element 37, polymer containing an alicyclic group or the like is able to be used.

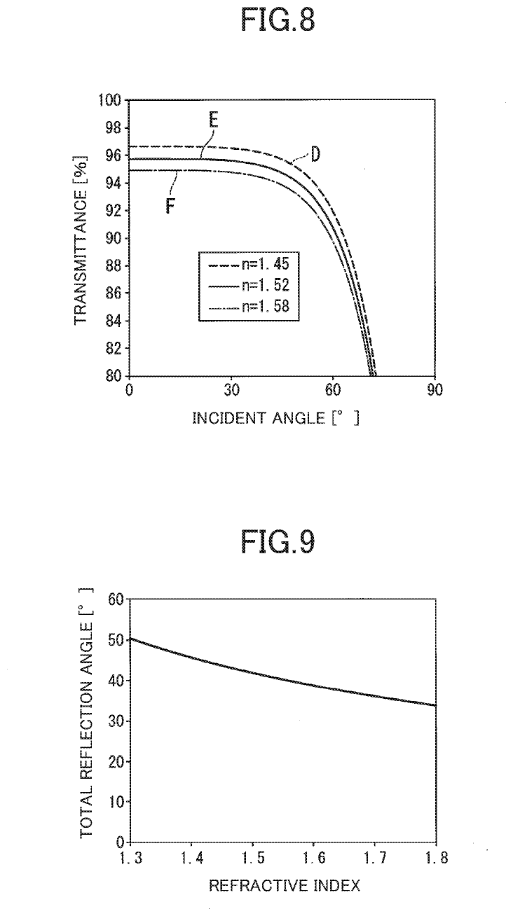

FIG. 8 is a graph illustrating a relationship between an incident angle and a transmittance of light.

In FIG. 8, a horizontal axis indicates an incident angle [°] of light on the daylighting member and a vertical axis indicates a transmittance [%] at an interface of the air and the daylighting member when the light is incident on the daylighting member from the air. It is indicated that a proportion of the light incident on the daylighting member is high as the transmittance becomes high, and the proportion of the light incident on the daylighting member is low as the transmittance becomes low. A curved line by a reference sign D indicates a graph with a refractive index n=1.45, a curved line by a reference sign E indicates a graph with a refractive index n=1.52, and a curved line by a reference sign F indicates a graph with a refractive index n=1.58.

As illustrated in FIG. 8, in a region where the incident angle β is about 0 to 30°, the transmittance is substantially fixed at 95 to 97% regardless of the refractive index, but when the incident angle β exceeds 30°, the transmittance tends to be sharply reduced as the incident angle increases. Further, as the refractive index of the material forming the prism structure element 37 is high, the transmittance is reduced. When the refractive index is too high, the reflectivity at the interface of the air and the prism structure element 37 becomes high, so that the sunlight is difficult to be transmitted through the inside of the prism structure element 37 and use efficiency of the sunlight is lowered.

FIG. 9 is a graph illustrating a relationship between the refractive index and a total reflection angle.

In FIG. 9, a horizontal axis indicates the refractive index and a vertical axis indicates the total reflection angle [°] at the interface of the daylighting member and the air when light is emitted from the daylighting member to the air.

As illustrated in FIG. 9, as the refractive index increases, the total reflection angle tends to be monotonously reduced. When the refractive index of the material forming the prism structure element 37 is too low, the total reflection angle increases and only light with a great incident angle is totally reflected at an interface of the prism structure element 37 and the air. In this case, a proportion of light that is transmitted without being totally reflected, that is, light that does not travel toward the ceiling in the room increases and use efficiency of the sunlight is lowered. Further, as the refractive index is reduced, a refraction angle at the prism structure element 37 is reduced, so that the sunlight is not allowed to be effectively refracted.

Here, inventors actually manufactured trials of daylighting members which are different in constituent material of the prism structure element 37 and evaluated a degree of generation of iridescent unevenness in each of the daylighting members.

The refractive index and the Abbe number of each of the materials are as indicated in a table 2.

Here, amorphous polyolefin-based resin was used as a material A and polycarbonate resin was used as a material B.

TABLE 2

| | Refractive index | Abbe number |
|---|---|---|
| Material A | 1.53 | 56 |
| Material B | 1.58 | 32 |

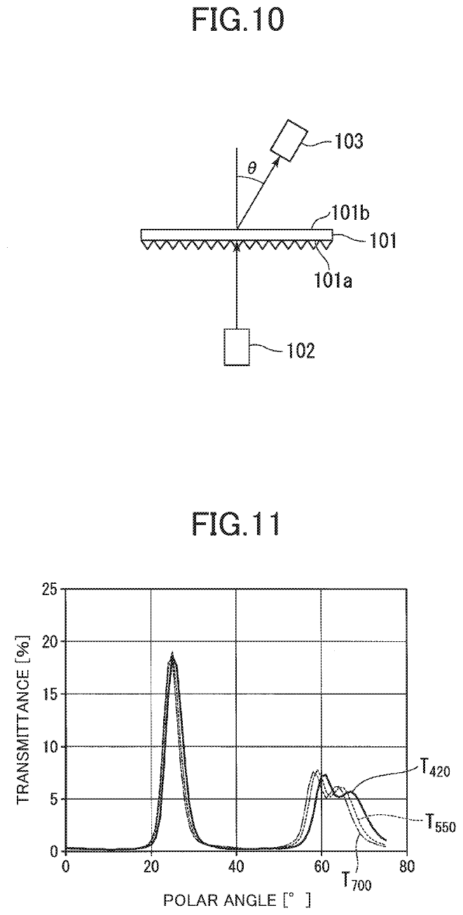

The evaluation was performed in such a manner that light was made perpendicularly incident from a light source 102 on a first surface 101a of a daylighting member 101, in which a prism structure element was formed, as illustrated in FIG. 10, light intensity was detected for each predetermined wavelength by a light receiver 103 arranged on a second surface 101b side, and a transmittance was calculated from the detected value. At this time, the light intensity was detected by changing an installation angle θ (polar angle) of the light receiver 103 relative to a direction normal to the second surface 101b.

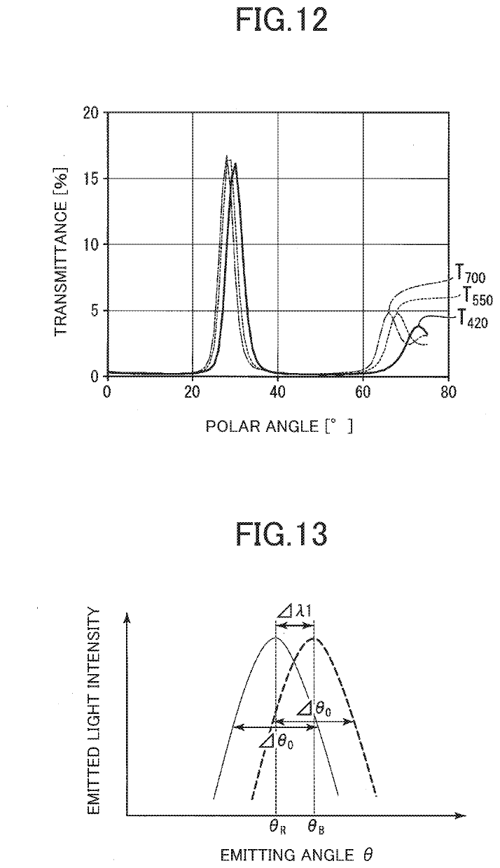

Evaluation results are illustrated in FIGS. 11 and 12.

In FIGS. 11 and 12, a horizontal axis indicates a polar angle [°] and a vertical axis indicates a transmittance [%].

FIG. 11 illustrates an evaluation result of the material A and FIG. 12 illustrates an evaluation result of the material B. Moreover, a curved line indicated by a reference sign T₄₂₀ indicates the transmittance for light with the wavelength of 420 nm, a curved line indicated by a reference sign T₅₅₀ indicates the transmittance for light with the wavelength of 550 nm, and a curved line indicated by a reference sign T₇₀₀ indicates the transmittance for light with the wavelength of 700 nm.

As illustrated in FIGS. 11 and 12, it was found that peaks of the transmittance were seen near the polar angle of 25° and near the polar angle of 60° in both of the materials and light was emitted to directions thereof. As illustrated in FIG. 11, in a case where the material A with the refractive index of 1.53 and the Abbe number of 56 was used, both of the peaks near the polar angle of 25° and near the polar angle of 60° had a small positional shift of a peak by the wavelength and almost no iridescent unevenness was visually recognized when the ceiling illuminated with the daylighting member was visually observed actually. On the other hand, as illustrated in FIG. 12, in a case where the material B with the refractive index of 1.58 and the Abbe number of 32 was used, a positional shift at the peak near the polar angle of 25° was small, but a positional shift at the peak near the polar angle of 60° was great and iridescent unevenness was visually recognized when the ceiling illuminated with the daylighting member was visually observed from a direction thereof.

Though the evaluation results of only two kinds of materials that are different in refractive index and Abbe number are disclosed here, the inventors feel that, according to other evaluation results, a material which has a non-flint region where the Abbe number is 50 or more and the refractive index is 1.45 or more and 1.58 or less is preferably used as the prism structure element 37. That is, in a case where the daylighting member was manufactured by using a material with the Abbe number of 50 or more, which is generally called a high Abbe number, there was less color break-up and iridescent unevenness was at an acceptable level. Moreover, in the evaluation, the shape of the prism structure element was designed by setting the refractive index to 1.515, but it was found that an emitting characteristic and a daylighting performance as designed were obtained when a material with the refractive index of 1.45 or more and 1.58 or less was used.

In a case of the daylighting member 57 of the present embodiment including the prism structure element 37 formed of a material with the high Abbe number, wavelength dispersion is low, so that a difference of the emitting angle by the wavelength is reduced as illustrated in FIG. 13. Specifically, an angle difference Δλ1 between a median θR of emitting angle distribution of red light (for example, with the wavelength of 650 nm) and a median θB of emitting angle distribution of blue light (for example, with the wavelength of 450 nm) is smaller than the angle difference Δλ in the conventional daylighting member illustrated in FIG. 2B. Further, the emitting angle distribution of the red light and the emitting angle distribution of the blue light each have a certain limited half-value width Δθ0.

At this time, in a situation where Δθ0>Δλ1 is satisfied, a comfortable space where the red light and the blue light are not visually recognized as being separated by eyes of the user, coloring of light in the radiation region of the ceiling or the like in the room is suppressed, and the person in the room does not feel uncomfortable is able to be provided.

As described above, according to the daylighting member 57 of the present embodiment, by using the prism structure element 37 formed of a material with less wavelength dispersion, dispersion of emitted light is suppressed. As a result, it is possible to achieve the daylighting member 57 capable of suppressing iridescent unevenness by emitted light. The daylighting member of PTL 1 described above has a problem that an effect of suppressing iridescent unevenness is not sufficiently obtained due to an incident angle of light, but the daylighting member 57 of the present embodiment achieves a light scattering effect by light passing through the prism structure element 37 regardless of an incident angle of light and is able to exert an effect of suppressing iridescent unevenness.

Also in the present embodiment, similarly to the first embodiment, without limitation to the triangle, prism structure elements having various sectional shapes are able to be adopted.

### Fourth Embodiment: Daylighting Member

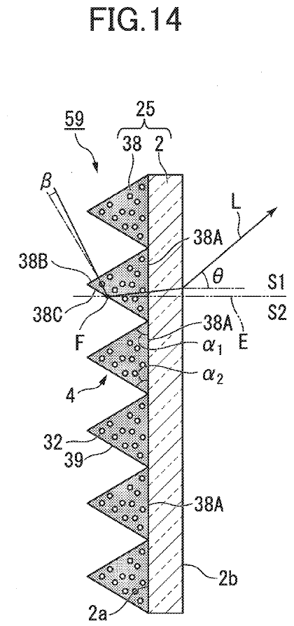

A daylighting member of a fourth embodiment will be described below with reference to FIG. 14.

A basic configuration of the daylighting member of the fourth embodiment is the same as that of the first embodiment and a configuration of a prism structure element is different from that of the first embodiment.

FIG. 14 is a sectional view of the daylighting member of the fourth embodiment.

In FIG. 14, a component common to that in the figure used in the first embodiment will be given the same reference sign and description thereof will be omitted.

As illustrated in FIG. 14, a daylighting member 59 is provided with a flat plate structure body 25 that includes the base 2 having light transmissivity and a plurality of prism structure elements 38 provided on the first surface 2a of the base 2 and having light transmissivity. In the present embodiment, the daylighting member 59 is installed so that the first surface 2a of the base 2, in which the plurality of prism structure elements 38 are provided, faces the outdoor side.

Each of the prism structure elements 38 is formed of a material that contains a base material 39 and the plurality of light scattering particles 32. The plurality of light scattering particles 32 each have a refractive index different from a refractive index of the base material 39 and are dispersed into the base material 39. As a constituent material of the light scattering particles 32, a material similar to the material cited in the first embodiment is able to be used.

The base material 39 is formed of a material that has the Abbe number of 50 or more, the refractive index of 1.45 or more and 1.58 or less, and visible light transmissivity. As the constituent material of the base material, which has the Abbe number of 50 or more and the refractive index of 1.45 or more and 1.58 or less, a material similar to the material cited in the second embodiment is able to be used. Moreover, similarly to the first embodiment, it is desirable that a half or more region of a surface area of each of the plurality of light scattering particles 32 is covered with the base material 39. According to the aforementioned configuration, the prism structure element 38 has a function of suppressing wavelength dispersion of light transmitted through the prism structure element 38.

According to the daylighting member 59 of the present embodiment, both of an effect that emitting angle distribution of light of each color is widened when the prism structure element 38 contains the light scattering particles 32 and an effect that an emitting angle difference by a wavelength is reduced when a material with less wavelength dispersion is used for the base material 39 of the prism structure element 38 are combined, so that the daylighting member 59 in which dispersion of emitted light is suppressed and which is capable of suppressing iridescent unevenness is able to be achieved.

Note that, also in the daylighting member of the third embodiment or the fourth embodiment, similarly to the second embodiment, a light transmitting portion that has a wavelength dispersion suppressing function may be provided in a region between adjacent prism structure elements.

### Fifth Embodiment: Daylighting Device

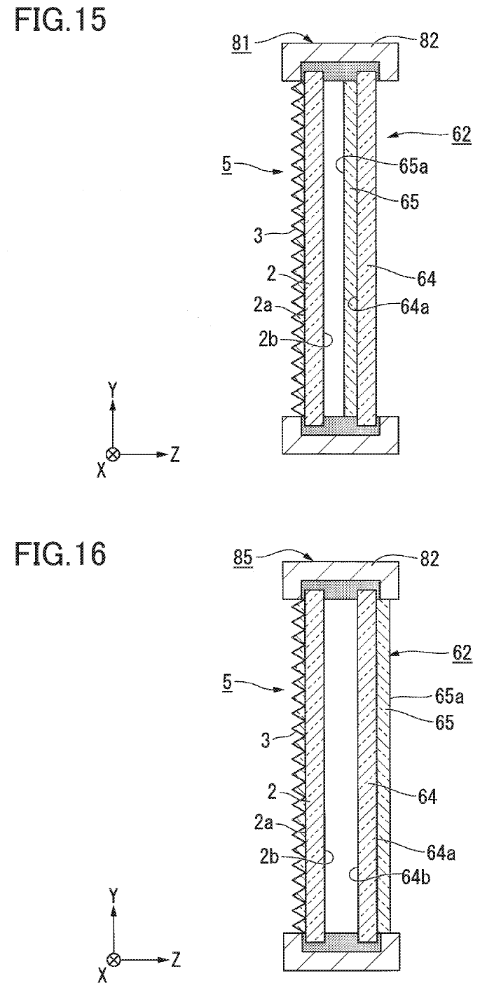

A fifth embodiment of the invention will be described below with reference to FIGS. 15 to 18.

A daylighting device of the fifth embodiment is obtained by combining a daylighting member and a light diffusing member.

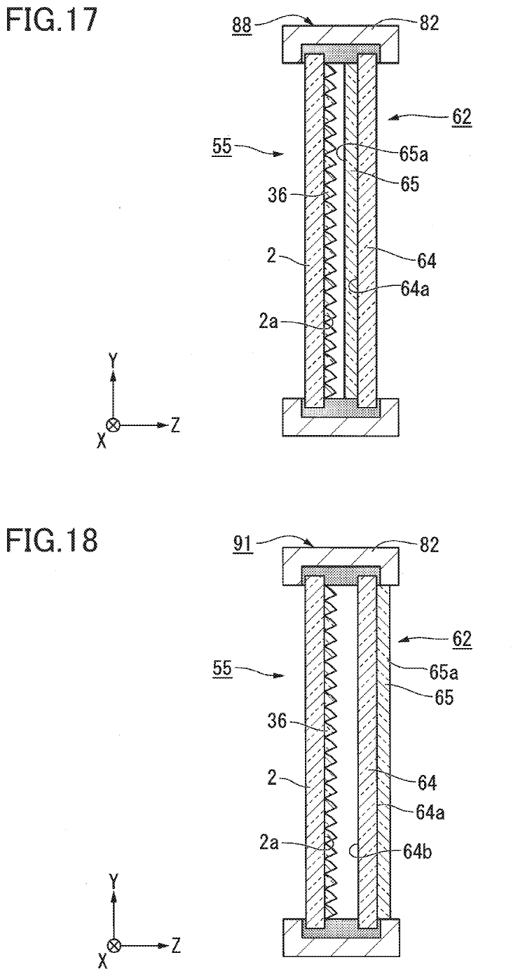

FIG. 15 is a sectional view of the daylighting device of the fifth embodiment. FIG. 16 is a sectional view of a daylighting device of a first modified example of the fifth embodiment. FIG. 17 is a sectional view of a daylighting device of a second modified example of the fifth embodiment. FIG. 18 is a sectional view of a daylighting device of a third modified example of the fifth embodiment.

In FIGS. 15 to 18, a component common to that in the figure used in the first embodiment will be given the same reference sign and description thereof will be omitted.

As illustrated in FIG. 15, a daylighting device 81 includes the daylighting member 5, a light diffusing member 62, and a frame 82 (support member). The daylighting member 5 includes the base 2 and the plurality of prism structure elements 3 provided on the first surface 2a of the base 2. The light diffusing member 62 includes a base 64 and a plurality of cylindrical lenses 65 provided on a first surface 64a of the base 64. The daylighting member 5 and the light diffusing member 62 are supported inside the frame 82 in a state of being arranged so as to be separated from each other with a predetermined interval. The daylighting device 81 is installed in a form of being suspended on the indoor side of window glass, for example, by any support member that is not illustrated.

As viewed from a direction vertical to the first surface 2a of the base 2, a direction in which a prism structure element 3 of the daylighting member 5 extends and a direction in which a cylindrical lens 65 of the light diffusing member 62 extends are substantially orthogonal to each other. In the present embodiment, the daylighting member 5 and the light diffusing member 62 are arranged so that the second surface 2b (surface where the plurality of prism structure elements 3 are not provided) of the base 2 and the first surface 64a (surface where the plurality of cylindrical lenses 65 are provided) of the base 64 face. That is, the daylighting member 5 is arranged so that the plurality of prism structure elements 3 face the outdoor side and the light diffusing member 62 is arranged so that the plurality of cylindrical lenses 65 face the outdoor side.

The light diffusing member 62 includes the plurality of cylindrical lenses 65 and thus has an anisotropic diffusion property for diffusing light mainly in a horizontal direction. As an example of the light diffusing member having the anisotropic diffusion property, instead of the cylindrical lenses 65, for example, a light diffusing member that extends so as to be thin and long in one direction and has an irregularity structure may be used, and may be installed so that a longitudinal direction of each concave part and each convex part is directed to a vertical direction and a transverse direction thereof is directed to a horizontal direction.

Since the daylighting device 81 of the present embodiment uses the daylighting member 5 of the first embodiment, the daylighting device 81 capable of suppressing iridescent unevenness is able to be achieved. Further, since the daylighting device 81 includes the light diffusing member 62, a range in which emitted light is radiated from the daylighting member 5 is able to be widened in the horizontal direction.

In the daylighting device 81 of the present embodiment, the daylighting member 5 and the light diffusing member 62 are provided as separate members, so that, for example, when any member is damaged or broken, the member is easily replaced.

Note that, various modified examples below are able to be adopted in the daylighting device 81 of the present embodiment.

FIG. 16 is a sectional view of a daylighting device 85 of the first modified example.

As illustrated in FIG. 16, in the daylighting device 85 of the first modified example, the daylighting member 5 and the light diffusing member 62 are arranged so that the second surface 2b (surface where the plurality of prism structure elements 3 are not provided) of the base 2 and a second surface 64b (surface where the plurality of cylindrical lenses 65 are not provided) of the base 64 face. That is, the daylighting member 5 is arranged so that the plurality of prism structure elements 3 face the outdoor side and the light diffusing member 62 is arranged so that the plurality of cylindrical lenses 65 face the indoor side.

FIG. 17 is a sectional view of a daylighting device 88 of the second modified example.

As illustrated in FIG. 17, in the daylighting device 88 of the second modified example, the daylighting member 55 and the light diffusing member 62 are arranged so that the first surface 2a (surface where the plurality of prism structure elements 36 are provided) of the base 2 and the first surface 64a (surface where the plurality of cylindrical lenses 65 are provided) of the base 64 face. That is, the daylighting member 55 is arranged so that the plurality of prism structure elements 36 face the indoor side and the light diffusing member 62 is arranged so that the plurality of cylindrical lenses 65 face the outdoor side.

FIG. 18 is a sectional view of a daylighting device 91 of the third modified example.

As illustrated in FIG. 18, in the daylighting device 91 of the third modified example, the daylighting member 55 and the light diffusing member 62 are arranged so that the first surface 2a (surface where the plurality of prism structure elements 36 are provided) of the base 2 and the second surface 64b (surface where the plurality of cylindrical lenses 65 are not provided) of the base 64 face. That is, the daylighting member 55 is arranged so that the plurality of prism structure elements 36 face the indoor side and the light diffusing member 62 is arranged so that the plurality of cylindrical lenses 65 face the indoor side.

In a case where the plurality of prism structure elements 3 face the outdoor side as in the daylighting devices 81 and 85 of the fifth embodiment and the first modified example, for example, prism structure elements each having a triangular sectional shape as illustrated in FIG. 1 or a pentagonal sectional shape as illustrated in FIG. 3 are able to be used. On the other hand, in a case where the plurality of prism structure elements 36 face the indoor side as in the daylighting devices 88 and 91 of the second modified example and the third modified example, for example, prism structure elements each having a quadrangular sectional shape as illustrated in FIG. 4 are able to be used.

### Sixth Embodiment: Daylighting Device

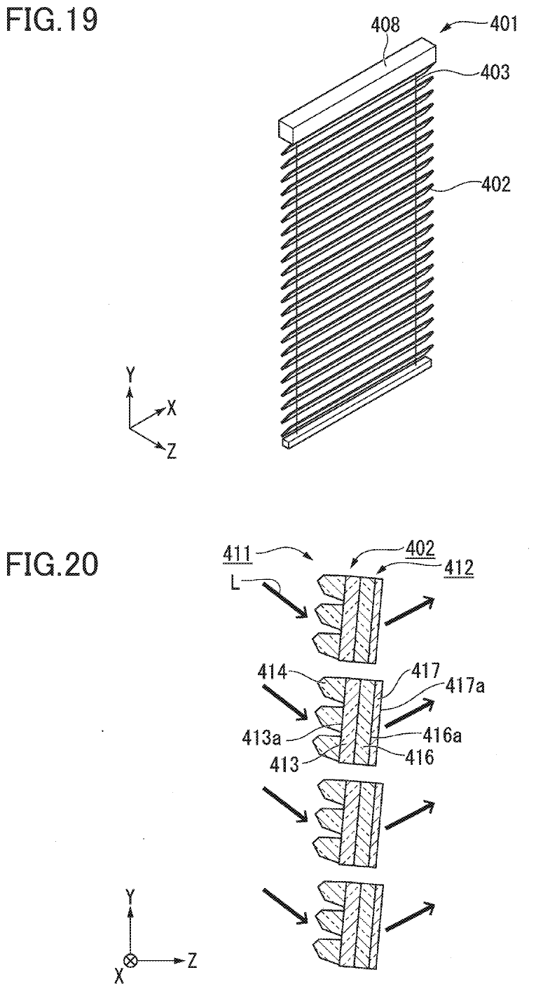

A sixth embodiment of the invention will be described below with reference to FIGS. 19 and 20.

A daylighting device of the sixth embodiment is an example in which the daylighting device is constituted by a daylighting blind.

FIG. 19 is a perspective view of the daylighting device of the sixth embodiment. FIG. 20 is a sectional view of the daylighting device.

In FIGS. 19 and 20, a component common to that in the figure used in the first embodiment will be given the same reference sign and description thereof will be omitted.

As illustrated in FIG. 19, a daylighting blind 401 includes a plurality of daylighting slats 402 arranged to be arrayed at a predetermined interval, a tilting mechanism (support mechanism) 403 that supports the plurality of daylighting slats 402 so as to be freely tilted, and an accommodation mechanism 408 that folds and accommodates the plurality of daylighting slats 402, which are linked by the tilting mechanism 403, so as to be able to be input and output.

As illustrated in FIG. 20, each of the plurality of daylighting slats 402 has a configuration in which a daylighting plate 411 and a light diffusing plate 412 are bonded. The daylighting plate 411 includes a base 413 and a plurality of prism structure elements 414 provided on a first surface 413a of the base 413. The light diffusing plate 412 includes a base 416 and a plurality of cylindrical lenses 417 provided on a first surface 416a of the base 416. Note that, a daylighting slat in which the base 416 and the base 413 are shared and the prism structure elements 414 and the cylindrical lenses 417 are each provided on each surface of one base may be used.

The tilting mechanism 403 includes a plurality of ladder cords. Although not illustrated, the plurality of ladder cords extend in a longitudinal direction of the daylighting slats 402 and support the plurality of daylighting slats 402. Although not illustrated, the tilting mechanism 403 includes an operation mechanism that performs an operation of moving a pair of vertical cords of ladder cords in a vertical direction to be reverse to each other. The tilting mechanism 403 enables to tilt the plurality of daylighting slats 402 in synchronization with each other by the operation of moving the pair of vertical cords by the operation mechanism.

The daylighting blind 401 is used in a state of being suspended from a ceiling surface on an indoor side of window glass (not illustrated) and opposing an inner surface of the window glass. At this time, the daylighting slats 402 are arranged in a direction in which an arrangement direction of the plurality of prism structure elements 414 coincides with a vertical direction (perpendicular direction) of the window glass. In other words, the daylighting slats 402 are arranged so that an extending direction of the plurality of prism structure elements 414 with respect to the window glass coincides with a transverse direction (horizontal direction) of the window glass. In a daylighting state, the daylighting slats 402 are arranged so that the prism structure elements 414 face the outdoor side and the cylindrical lenses 417 face the indoor side.

As illustrated in FIG. 20, in the daylighting blind 401 opposing the inner surface of the window glass, the light L, which has entered into the room through the window glass, is radiated toward the ceiling of the room while changing a travelling direction by the plurality of prism structure elements 414. The light L travelling to the ceiling is reflected by the ceiling and illuminates the room, and is thus used instead of illumination light. Accordingly, in a case where such a daylighting blind 401 is used, it is possible to expect an energy saving effect of saving energy consumed by lighting equipment in a building in a daytime.

Also in the present embodiment, an effect similar to that of the fifth embodiment that the daylighting device capable of suppressing iridescent unevenness is able to be achieved is obtained.

According to the daylighting blind 401, it is possible to adjust an angle of the light L travelling to the ceiling by tilting the plurality of daylighting slats 402. In addition, it is possible to adjust a quantity of the light incident from between the plurality of daylighting slats 402.

As described above, in a case where the daylighting blind 401 of the present embodiment is used, it is possible to efficiently take outdoor natural light (sunlight) into the room and cause a person in the room to feel that a deep inside of the room is bright without being dazzled.

### Seventh Embodiment: Daylighting Device

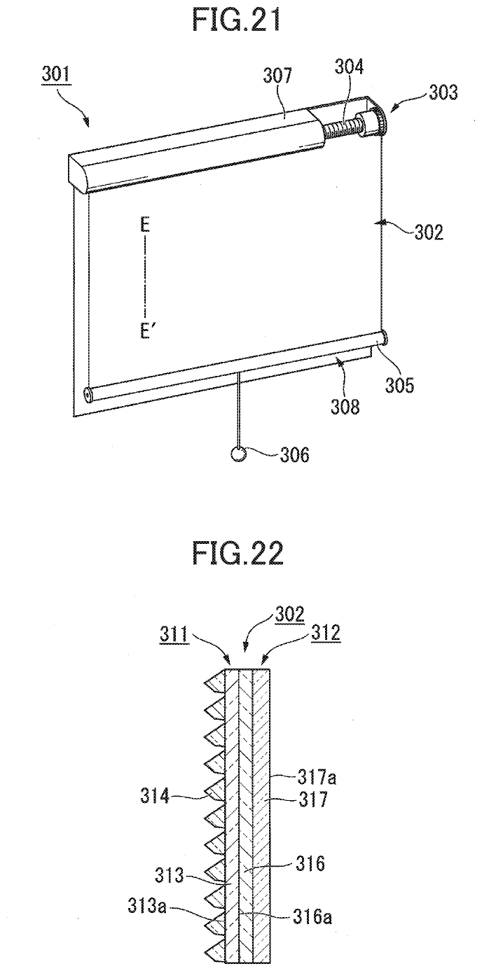

A seventh embodiment of the invention will be described below with reference to FIGS. 21 and 22.

A daylighting device of the seventh embodiment is an example that the daylighting device is constituted by a daylighting rolling screen.

FIG. 21 is a perspective view of the daylighting device of the seventh embodiment. FIG. 22 is a sectional view of the daylighting device.

In FIGS. 21 and 22, a component common to that in the figure used in the first embodiment will be given the same reference sign and description thereof will be omitted.

As illustrated in FIG. 21, a daylighting rolling screen 301 includes a daylighting screen 302 and a winding mechanism 303 that supports the daylighting screen 302 so as to be freely wound up.

As illustrated in FIG. 22, the daylighting screen 302 has a configuration in which a daylighting member 311 and a light diffusing member 312 are bonded. The daylighting member 311 includes a base 313 and a plurality of prism structure elements 314 provided on a first surface 313a of the base 313. The light diffusing member 312 includes a base 316 and a plurality of cylindrical lenses 317 provided on a first surface 316a of the base 316. A daylighting screen in which the base 316 and the base 313 are shared and the prism structure elements 314 and the cylindrical lenses 317 are each provided on each surface of one base may be used.

As illustrated in FIG. 21, the winding mechanism 303 includes a core (support member) 304 attached along an upper end part of the daylighting screen 302, a bottom tube (support member) 305 attached along a lower end part of the daylighting screen 302, a pulling cord 306 attached to a center of the lower end part of the daylighting screen 302, and an accommodation case 307 that accommodates the daylighting screen 302 wound around the core 304.

As a pull-cord type, the winding mechanism 303 is able to fix the daylighting screen 302 at a pulled position, or automatically wind the daylighting screen 302 around the core 304 by further pulling the pulling cord 306 from the pulled position and thereby releasing the fixation. Note that, the winding mechanism 303 is not limited to such a pull-cord type, and may be, for example, a winding mechanism of a chain type that rotates the core 304 with a chain or an automatic winding mechanism that rotates the core 304 with a motor.

The daylighting rolling screen 301 having such a configuration is used in a state where the accommodation case 307 is fixed to an upper part of window glass 308 and the daylighting screen 302 accommodated in the accommodation case 307 opposes an inner surface of the window glass 308 while pulling the daylighting screen 302 with the pulling cord 306. At this time, the daylighting screen 302 is arranged in a direction in which an arrangement direction of the plurality of prism structure elements 314 with respect to the window glass 308 coincides with a vertical direction (perpendicular direction) of the window glass 308. That is, the daylighting screen 302 is arranged so that the longitudinal direction of the plurality of prism structure elements 314 with respect to the window glass 308 coincides with the transverse direction (horizontal direction) of the window glass 308. The daylighting rolling screen 301 is installed so that the prism structure elements 314 face the outdoor side and the cylindrical lenses 317 face the indoor side.

In the daylighting screen 302 opposing the inner surface of the window glass 308, the light, which has entered into the room through the window glass 308, is radiated toward the ceiling of the room while changing a travelling direction by the plurality of prism structure elements 314. The light travelling to the ceiling is reflected by the ceiling and illuminates the room, and is thus used instead of illumination light. Accordingly, when such a daylighting rolling screen 301 is used, it is possible to expect an energy saving effect of saving energy consumed by lighting equipment in a building in a daytime.

Also in the present embodiment, an effect similar to that of the fifth embodiment that the daylighting device capable of suppressing iridescent unevenness is able to be achieved is obtained.

As described above, in a case where the daylighting rolling screen 301 of the present embodiment is used, it is possible to efficiently take outdoor natural light (sunlight) into the room and cause a person in the room to feel that a deep inside of the room is bright without being dazzled.

### [Lighting System]

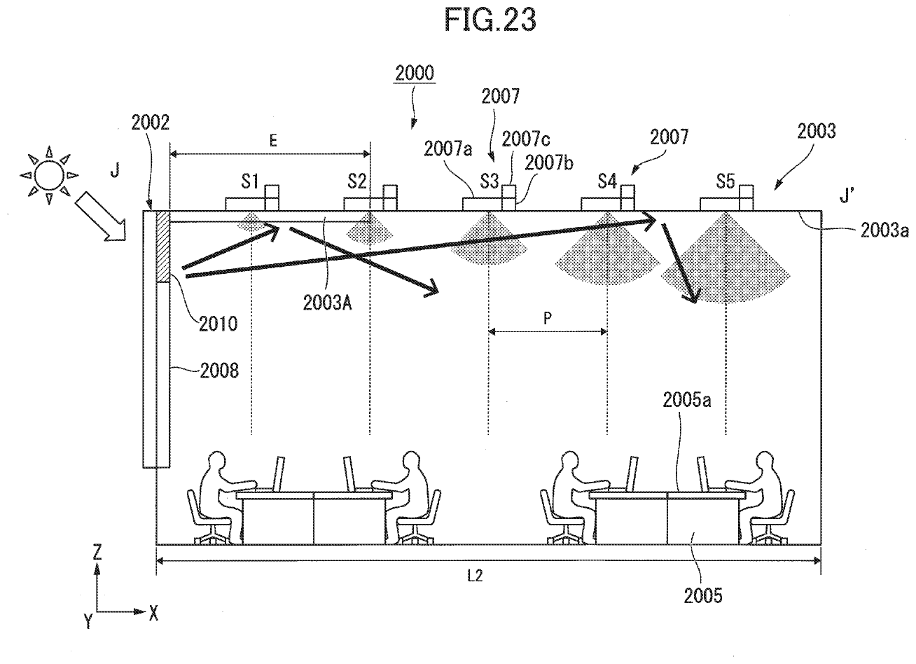

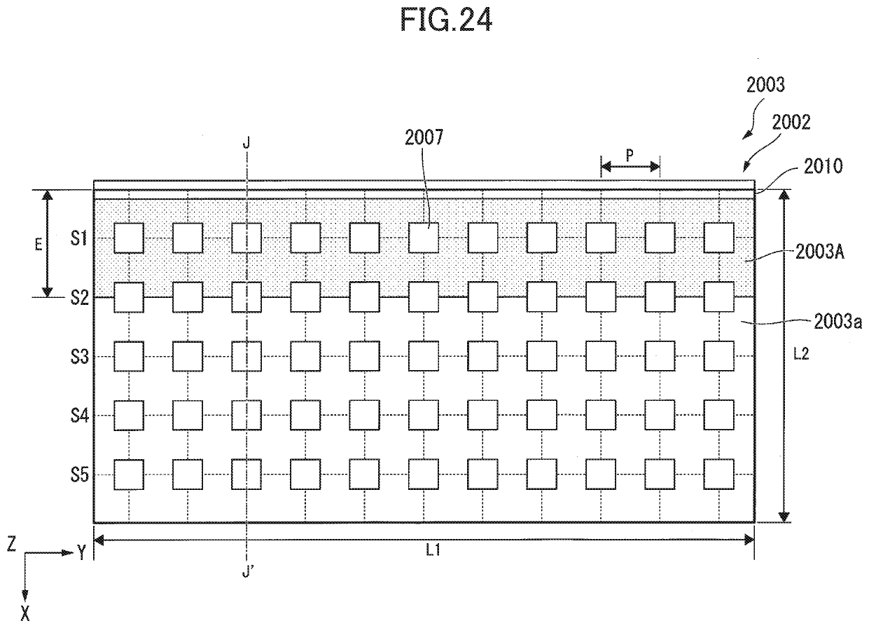

FIG. 23 illustrates a room model 2000 including a daylighting system 2010 and is a sectional view taken along a line J-J′ of FIG. 24.

FIG. 24 is a plan view illustrating a ceiling of the room model 2000.

A ceiling material forming a ceiling 2003a of a room 2003 into which sunlight is guided is desired to have high light reflectivity. As illustrated in FIGS. 23 and 24, a light reflective ceiling material 2003A is installed on the ceiling 2003a of the room 2003 as a ceiling material having light reflectivity. The light reflective ceiling material 2003A promotes guiding of external light from the daylighting system 2010 installed on a window 2002 into the deep inside of the room. The light reflective ceiling material 2003A is installed on the ceiling 2003a on a window side. Specifically, the light reflective ceiling material 2003A is installed in a predetermined region E (region within about 3 m from the window 2002) of the ceiling 2003a.

As described above, the light reflective ceiling material 2003A efficiently guides, to the deep inside the room, sunlight which is guided into the room through the window 2002 on which the daylighting system 2010 constituted by the daylighting device of any of the embodiments is installed. The sunlight guided toward the ceiling 2003a in the room from the daylighting system 2010 is reflected by the light reflective ceiling material 2003A and changes a direction to illuminate a desk top surface 2005a of a desk 2005 placed in the deep inside of the room, so that an effect of making the desk top surface 2005a bright is exhibited.

The light reflective ceiling material 2003A may have diffusion reflectivity or may have specular reflectivity, but, in order to achieve both the effect of making the desk top surface 2005a of the desk 2005 placed in the deep inside of the room bright and the effect of suppressing glare light uncomfortable for a person in the room, preferably has both properties mixed appropriately.

Most of the light guided into the room by the daylighting system 2010 travels to the ceiling. A quantity of light is generally sufficient near the window 2002 in many cases. Thus, the daylighting system and the light reflective ceiling material 2003A as described above are used in combination, and thereby it is possible to allocate the light incident on the ceiling (region E) near the window to the deep inside of the room where a quantity of light is less than that near the window side.

The light reflective ceiling material 2003A is able to be created, for example, by embossing a metal plate made of aluminum or the like with irregularity of about several tens μm or by applying vapor deposition of a metal thin film made of aluminum or the like to a surface of a resin base on which similar irregularity is formed. Alternatively, irregularity may be formed by embossing a curved surface with a longer interval.

Further, by appropriately changing an embossing shape to be formed on the light reflective ceiling material 2003A, it is possible to control a light distribution characteristic of light and distribution of light in the room. For example, when the embossment is performed in a stripe shape extending to the deep inside of the room, the light reflected by the light reflective ceiling material 2003A expands in a right-and-left direction (direction intersecting a longitudinal direction of irregularity) of the window 2002. When a size and a direction of the window 2002 are limited, by using such a characteristic, it is possible to diffuse the light in a horizontal direction and reflect the light toward the deep inside of the room by the light reflective ceiling material 2003A.

The daylighting system 2010 is used as a part of a lighting system of the room 2003. The lighting system is constituted by components of the entire room, for example, including the daylighting system 2010, a plurality of indoor lighting devices 2007, a control system thereof, the light reflective ceiling material 2003A installed on the ceiling 2003a.

The daylighting system 2010 is installed on the window 2002 of the room 2003. The daylighting system 2010 is arranged on an upper part of the window and a light shielding portion 2008 is provided on a lower part thereof.

In the room 2003, the plurality of indoor lighting devices 2007 are arranged in a lattice manner in the right-and-left direction (Y-direction) of the window 2002 and in a depth direction (X-direction) of the room. The plurality of indoor lighting devices 2007 constitute the entire lighting system of the room 2003 along with the daylighting system 2010.

As illustrated in FIGS. 23 and 24, for example, the ceiling 2003a of an office in which a length L₁ of the room 2003 in a width direction (right-and-left direction of the window 2002, Y-direction) is 18 m and a length L₂ of the room 2003 in the depth direction (X-direction) is 9 m is illustrated. Here, the indoor lighting devices 2007 are arranged in a lattice manner at each interval P of 1.8 m in the horizontal direction (Y-direction) and the depth direction (X-direction) of the ceiling 2003a. More specifically, fifty indoor lighting devices 2007 are arrayed with 10 rows (Y-direction)×5 columns (X-direction).

Each of the indoor lighting devices 2007 includes indoor lighting equipment 2007a, a brightness detection unit 2007b, and a control unit 2007c. The indoor lighting device 2007 has a configuration in which the brightness detection unit 2007b and the control unit 2007c are integrated with the indoor lighting equipment 2007a.

The indoor lighting devices 2007 may include a plurality of pieces of indoor lighting equipment 2007a and a plurality of brightness detection units 2007b. However, one brightness detection unit 2007b is provided for each piece of indoor lighting equipment 2007a. The brightness detection unit 2007b receives light reflected by a surface to be illuminated by the indoor lighting equipment 2007a and detects illuminance of the illuminated surface. Here, the illuminance of the desk top surface 2005a of the desk 2005 placed in the room is detected by the brightness detection unit 200b.

Control units 2007c each of which is provided in each of the indoor lighting devices 2007 are connected to one another. Each of the indoor lighting devices 2007 performs feedback control, by the control units 2007c connected to one another, to adjust a light output of an LED lamp of each indoor lighting equipment 2007a so that the illuminance of the desk top surface 2005a that is detected by each brightness detection unit 2007b is fixed target illuminance LO (for example, average illuminance: 750 1×).

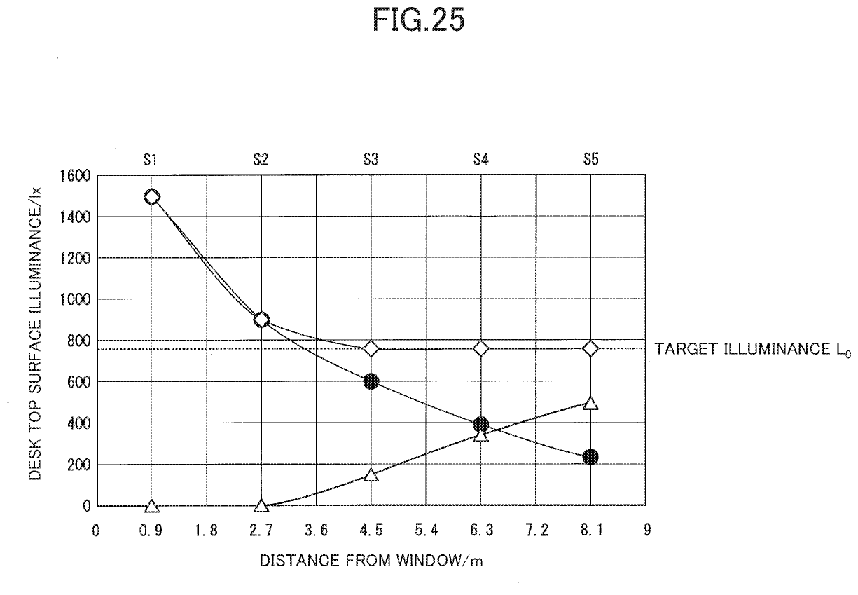

FIG. 25 is a graph indicating a relationship between illuminance of light (natural light) taken into the room by the daylighting device and illuminance by the indoor lighting devices (lighting system). In FIG. 25, a vertical axis indicates the illuminance (1×) of the desk top surface, and a horizontal axis indicates a distance (m) from the window. Moreover, a broken line in the figure indicates the target illuminance in the room. (●: illuminance by the daylighting device, Δ: illuminance by the indoor lighting devices, and ⋄: total illuminance)

As illustrated in FIG. 25, the illuminance of the desk top surface resulting from light taken by the daylighting system 2010 is brighter as being close to the window, and an effect thereof is reduced as being away from the window. In the room to which the daylighting system 2010 is applied, such illuminance distribution in the depth direction of the room is generated due to natural lighting from the window in a daytime. Then, the daylighting system 2010 is used in combination with the indoor lighting devices 2007 which compensate for the illuminance distribution in the room.

Each of the indoor lighting devices 2007 installed on the ceiling in the room detects average illuminance under the device by the brightness detection unit 2007b, and is turned on by being subjected to lighting control so that illuminance of all desk top surfaces in the room becomes fixed target illuminance L0. Accordingly, the indoor lighting devices 2007 in a column S1 and a column S2, which are installed in a vicinity of the window, are hardly turned on, and the indoor lighting devices 2007 are turned on while output is increased as being deep inside the room, that is, in an order of a column S3, a column S4, and a column S5. As a result, the desk top surfaces in the room are illuminated with both of lighting by the natural lighting and lighting by the indoor lighting devices 2007, so that it is possible to achieve 750 1× (recommended maintained illuminance in an office according to “JIS 29110 General rules of lighting”), which is illuminance of a desk top surface regarded to be sufficient for working, throughout the whole of the room.

As described above, by using the daylighting system 2010 and the lighting system (indoor lighting devices 2007) in combination, light is able to reach deep inside the room, so that it is possible to further increase brightness in the room and secure the illuminance of the desk top surface, which is regarded to be sufficient for working, throughout the whole of the room. Thus, a bright light environment which is much more stable is obtained without being affected by the seasons or weather.

Note that, a technical scope of the invention is not limited to the aforementioned embodiments and may be variously modified in a range not departing from the concept of the invention.

For example, specific description of the number, a shape, a size, arrangement, a material, and the like of each of components constituting a daylighting member and a daylighting device is not limited to exemplification in the aforementioned embodiments and may be appropriately changed.

Moreover, though an example of a daylighting member in which a base and a prism structure element are separate members is cited in the aforementioned embodiments, a daylighting member constituted by one flat plate structure body in which a base and a prism structure element are integrated may be provided. In this case, for example, the daylighting member is able to be created by an extrusion molding method with use of a low-wavelength dispersion material having a thermoplastic property, for example.

Moreover, the light diffusing member in the aforementioned embodiment may be used in combination with a daylighting member including a plurality of daylighting units or may be used in combination with a daylighting member not including a plurality of daylighting units.

### INDUSTRIAL APPLICABILITY

Some aspects of the invention are able to be used for a daylighting member that takes external light such as sunlight into a room and a daylighting device including the daylighting member.

### REFERENCE SIGNS LIST

3, 35, 36, 37, 38, 314, 414 . . . prism structure element, 21, 22, 23, 24, 25 . . . flat plate structure body, 31, 39 . . . base material, 32 . . . light scattering particle, 33 . . . light transmitting portion, 49, 51, 55, 57, 59, 101 . . . daylighting member, 81, 85, 88, 91 . . . daylighting device, and 82 . . . frame (support member).

1. A daylighting member comprising
a flat plate structure body including a plurality of prism structure bodies, wherein
the plurality of prism structure bodies are provided in parallel on a first surface side of the flat plate structure body,
the flat plate structure body has an incident surface, a reflecting surface, and an emitting surface,
the incident surface, the reflecting surface, and the emitting surface are not parallel to one another, and
each of the prism structure bodies has a function of suppressing wavelength dispersion of light transmitted through the prism structure body,
wherein the prism structure body is formed of a material that contains a base material and a plurality of particles having a refractive index different from a refractive index of the base material and dispersed into the base material.

2. (canceled)

3. The daylighting member according to claim 1, wherein a half or more of a region of a surface area of each of the plurality of particles is covered with the base material.

4. The daylighting member according to claim 1, wherein the base material is formed of a material that has an Abbe number of 50 or more, the refractive index of 1.45 or more and 1.58 or less, and visible light transmissivity.

5. (canceled)

6. The daylighting member according to claim 1, wherein the flat plate structure body further includes a light transmitting portion provided in a region between two of the prism structure bodies adjacent to each other, and
the light transmitting portion has a function of suppressing wavelength dispersion of light transmitted through the light transmitting portion.

7. The daylighting member according to claim 6, wherein the light transmitting portion contains a light scattering particle.

8. A daylighting device comprising:
the daylighting member according to claim 1; and
a support member that supports the daylighting member.

9. The daylighting device according to claim 8, further comprising a light diffusing member provided on a light emitting side of the daylighting member.
